(19) United States
(12) Patent Application Publication
(10) Pub. No.: US 2025/0350808 A1
(43) Pub. Date: Nov. 13, 2025

(54) IDENTIFYING CHANNEL MEMBERSHIP RECOMMENDATIONS FOR A CHANNEL ON A CONTENT PLATFORM

(71) Applicant: Google LLC, Mountain View, CA (US)

(72) Inventors: Antonio Deromir Neves da Silva, JR., Zurich (CH); Martin Krivánek, Thalwil (CH); René Jonathan Vennik, Freienbach (CH); Silviu Bota, Horgen (CH); Briana Yvonne Seiderman, Zurich (CH)

(21) Appl. No.: 19/204,263

(22) Filed: May 9, 2025

Related U.S. Application Data
(60) Provisional application No. 63/645,817, filed on May 10, 2024.

(51) Int. Cl. H04N 21/482

(52) U.S. Cl. CPC H04N 21/4826

(57) ABSTRACT

Systems and methods for identifying channel membership recommendations for a channel on a content sharing platform are provided. A request pertaining to a creation of a channel membership for a channel of a first channel owner of a plurality of channel owners of the content sharing platform is received. One or more channel owners are identified, wherein identifying the one or more channel owners comprises: identifying a plurality of channel characteristics pertaining to a plurality of channels; determining a respective channel owner similarity ranking based on the plurality of channel characteristics; and identifying, based on the channel owner similarity rankings, a subset of the plurality of channel owners that satisfies a threshold channel owner similarity criterion. A channel UI of the content sharing platform is caused to be presented to the first channel owner, the channel UI providing information about the features of the corresponding one or more channel memberships.

This application claims the benefit of priority from U.S. Provisional Application No. 63/645,817, filed May 10, 2024, which is incorporated herein by reference.

### TECHNICAL FIELD

Aspects and implementations of the present disclosure relate to identifying channel membership recommendations for a channel on a content platform.

### BACKGROUND

A platform (e.g., a content platform) can transmit media items to client devices connected to the platform via a network. A media item can include an audio item or a video item, in some instances. Users can consume the transmitted media items via a user interface (UI) provided by the platform. In some instances, media items can be provided to users through channels. A channel can include content provided by a channel owner. A user can subscribe to the channel to gain access to the media items of the channel. In some instances, a channel owner can provide channel memberships offering various channel features, where a user can subscribe to the channel membership and gain access to the various channel features.

### SUMMARY

The below summary is a simplified summary of the disclosure in order to provide a basic understanding of some aspects of the disclosure. This summary is not an extensive overview of the disclosure. It is intended neither to identify key or critical elements of the disclosure, nor delineate any scope of the particular implementations of the disclosure or any scope of the claims. Its sole purpose is to present some concepts of the disclosure in a simplified form as a prelude to the more detailed description that is presented later.

An aspect of the disclosure provides a computer-implemented method that includes receiving, by a processing device of a content sharing platform, a request of a first channel owner of a plurality of channel owners of the content sharing platform, the request pertaining to a creation of a channel membership for a channel of the first channel owner. The method further includes identifying one or more channel owners of the plurality of channel owners to derive features of corresponding one or more channel memberships for the channel membership for the channel of the first channel owner, wherein identifying the one or more channel owners includes: identifying a plurality of channel characteristics pertaining to a plurality of channels of the plurality of channel owners; determining, for each channel owner of the plurality of channel owners, a respective channel owner similarity ranking based on the plurality of channel characteristics; and identifying, based on the channel owner similarity rankings, a subset of the plurality of channel owners that satisfies a threshold channel owner similarity criterion, the subset of the plurality of channel owners comprising the one or more channel owners. The method further includes causing a channel user interface (UI) of the content sharing platform to be presented to the first channel owner, the channel UI providing information about the features of the corresponding one or more channel memberships associated with the identified one or more channel owners.

In some implementations, the plurality of channel characteristics pertaining to the plurality of channels of the plurality of channel owners comprises at least one or more of: a number of subscribers of a channel of the plurality of channels of a channel owner of the plurality of channel owners, a content type of a channel of the plurality of channels of a channel owner of the plurality of channel owners, a language of a channel of the plurality of channels of a channel owner of the plurality of channel owners, a geographic region in which one or more subscribers of a channel of the plurality of channels of a channel owner of the plurality of channel owners resides, a good standing status of a channel of the plurality of channels of a channel owner of the plurality of channel owners, a content quality of a channel of the plurality of channels of a channel owner of the plurality of channel owners, or a number of channel memberships of a channel owner of the plurality of channel owners.

In some implementations, determining the respective channel owner similarity ranking includes comparing a channel characteristic of the channel of the first channel owner to a channel characteristic of a second channel of a second channel owner of the plurality of channel owners; and determining, based on the comparing, a channel owner similarity ranking of the second channel owner of the plurality of channel owners.

In some implementations, identifying the subset of the plurality of channel owners that satisfies the threshold channel owner similarity criterion includes determining, for a second channel owner of the plurality of channel owners, that the respective channel owner similarity ranking of the second channel owner exceeds a threshold channel owner similarity value; and in response to determining that the respective channel owner similarity ranking of the second channel owner exceeds the threshold channel owner similarity value, associating the second channel owner with the subset of the plurality of channel owners that satisfies the threshold channel owner similarity criterion.

In some embodiments, the method further includes in response to identifying the plurality of channel characteristics pertaining to the plurality of channels of the plurality of channel owners, removing, based on one or more channel characteristics of the plurality of channel characteristics, one or more channel owners from the plurality of channel owners.

In some implementations, the channel UI displays one or more visual representations of the one or more channel owners.

In some implementations, causing the channel UI of the content sharing platform to be presented to the first channel owner further includes displaying the identified one or more channel owners; receiving, from the first channel owner, a selection of one or more UI elements of the channel UI, wherein the one or more UI elements are selectable to allow the first channel owner to select any of the identified one or more channel owners; and in response to receiving the selection, causing the channel UI to be modified to display a subset of channel features for a channel membership of the selected channel owner.

In some embodiments, the method further includes receiving a selection of one or more features of the subset of channel features for the channel membership of the selected channel owner; and integrating the selected features into the channel membership of the channel of the first channel owner.

An aspect of the disclosure provides a system including a memory device and a processing device communicatively coupled to the memory device. The processing device performs operations including receiving, by a processing device of a content sharing platform, a request of a first channel owner of a plurality of channel owners of the content sharing platform, the request pertaining to a creation of a channel membership for a channel of the first channel owner. The processing device is to perform operations further including identifying one or more channel owners of the plurality of channel owners to derive features of corresponding one or more channel memberships for the channel membership for the channel of the first channel owner, wherein identifying the one or more channel owners includes: identifying a plurality of channel characteristics pertaining to a plurality of channels of the plurality of channel owners; determining, for each channel owner of the plurality of channel owners, a respective channel owner similarity ranking based on the plurality of channel characteristics; and identifying, based on the channel owner similarity rankings, a subset of the plurality of channel owners that satisfies a threshold channel owner similarity criterion, the subset of the plurality of channel owners comprising the one or more channel owners. The processing device is to perform operations further including causing a channel user interface (UI) of the content sharing platform to be presented to the first channel owner, the channel UI providing information about the features of the corresponding one or more channel memberships associated with the identified one or more channel owners.

In some implementations, the plurality of channel characteristics pertaining to the plurality of channels of the plurality of channel owners comprises at least one or more of: a number of subscribers of a channel of the plurality of channels of a channel owner of the plurality of channel owners, a content type of a channel of the plurality of channels of a channel owner of the plurality of channel owners, a language of a channel of the plurality of channels of a channel owner of the plurality of channel owners, a geographic region in which one or more subscribers of a channel of the plurality of channels of a channel owner of the plurality of channel owners resides, a good standing status of a channel of the plurality of channels of a channel owner of the plurality of channel owners, a content quality of a channel of the plurality of channels of a channel owner of the plurality of channel owners, or a number of channel memberships of a channel owner of the plurality of channel owners.

In some implementations, to determine the respective channel owner similarity ranking, the processing device is to perform operations further including comparing a channel characteristic of the channel of the first channel owner to a channel characteristic of a second channel of a second channel owner of the plurality of channel owners; and determining, based on the comparing, a channel owner similarity ranking of the second channel owner of the plurality of channel owners.

In some implementations, to identify the subset of the plurality of channel owners that satisfies the threshold channel owner similarity criterion, the processing device is to perform operations further including determining, for a second channel owner of the plurality of channel owners, that the respective channel owner similarity ranking of the second channel owner exceeds a threshold channel owner similarity value; and in response to determining that the respective channel owner similarity ranking of the second channel owner exceeds the threshold channel owner similarity value, associating the second channel owner with the subset of the plurality of channel owners that satisfies the threshold channel owner similarity criterion.

In some embodiments the processing device is to perform operations further including, in response to identifying the plurality of channel characteristics pertaining to the plurality of channels of the plurality of channel owners, removing, based on one or more channel characteristics of the plurality of channel characteristics, one or more channel owners from the plurality of channel owners.

In some implementations, the channel UI displays one or more visual representations of the one or more channel owners.

In some implementations, to cause the channel UI of the content sharing platform to be presented to the first channel owner, the processing device is to perform operations further including displaying the identified one or more channel owners; receiving, from the first channel owner, a selection of one or more UI elements of the channel UI, wherein the one or more UI elements are selectable to allow the first channel owner to select any of the identified one or more channel owners; and in response to receiving the selection, causing the channel UI to be modified to display a subset of channel features for a channel membership of the selected channel owner.

In some implementations, the processing device is to perform operations further including receiving a selection of one or more features of the subset of channel features for the channel membership of the selected channel owner; and integrating the selected features into the channel membership of the channel of the first channel owner.

An aspect of the disclosure provides a computer program including instructions that, when the program is executed by a processing device, cause the processing device to perform operations including receiving, by a processing device of a content sharing platform, a request of a first channel owner of a plurality of channel owners of the content sharing platform, the request pertaining to a creation of a channel membership for a channel of the first channel owner. The processing device is to perform operations further including identifying one or more channel owners of the plurality of channel owners to derive features of corresponding one or more channel memberships for the channel membership for the channel of the first channel owner, wherein identifying the one or more channel owners includes: identifying a plurality of channel characteristics pertaining to a plurality of channels of the plurality of channel owners; determining, for each channel owner of the plurality of channel owners, a respective channel owner similarity ranking based on the plurality of channel characteristics; and identifying, based on the channel owner similarity rankings, a subset of the plurality of channel owners that satisfies a threshold channel owner similarity criterion, the subset of the plurality of channel owners comprising the one or more channel owners. The processing device is to perform operations further including causing a channel user interface (UI) of the content sharing platform to be presented to the first channel owner, the channel UI providing information about the features of the corresponding one or more channel memberships associated with the identified one or more channel owners.

In some implementations, the plurality of channel characteristics pertaining to the plurality of channels of the plurality of channel owners comprises at least one or more of: a number of subscribers of a channel of the plurality of channels of a channel owner of the plurality of channel owners, a content type of a channel of the plurality of channels of a channel owner of the plurality of channel owners, a language of a channel of the plurality of channels of a channel owner of the plurality of channel owners, a geographic region in which one or more subscribers of a channel of the plurality of channels of a channel owner of the plurality of channel owners resides, a good standing status of a channel of the plurality of channels of a channel owner of the plurality of channel owners, a content quality of a channel of the plurality of channels of a channel owner of the plurality of channel owners, or a number of channel memberships of a channel owner of the plurality of channel owners.

In some implementations, to determine the respective channel owner similarity ranking, the processing device is to perform operations further including comparing a channel characteristic of the channel of the first channel owner to a channel characteristic of a second channel of a second channel owner of the plurality of channel owners; and determining, based on the comparing, a channel owner similarity ranking of the second channel owner of the plurality of channel owners.

In some implementations, to identify the subset of the plurality of channel owners that satisfies the threshold channel owner similarity criterion, the processing device is to perform operations further including determining, for a second channel owner of the plurality of channel owners, that the respective channel owner similarity ranking of the second channel owner exceeds a threshold channel owner similarity value; and in response to determining that the respective channel owner similarity ranking of the second channel owner exceeds the threshold channel owner similarity value, associating the second channel owner with the subset of the plurality of channel owners that satisfies the threshold channel owner similarity criterion.

In some embodiments the processing device is to perform operations further including, in response to identifying the plurality of channel characteristics pertaining to the plurality of channels of the plurality of channel owners, removing, based on one or more channel characteristics of the plurality of channel characteristics, one or more channel owners from the plurality of channel owners.

In some implementations, the channel UI displays one or more visual representations of the one or more channel owners.

In some implementations, to cause the channel UI of the content sharing platform to be presented to the first channel owner, the processing device is to perform operations further including displaying the identified one or more channel owners; receiving, from the first channel owner, a selection of one or more UI elements of the channel UI, wherein the one or more UI elements are selectable to allow the first channel owner to select any of the identified one or more channel owners; and in response to receiving the selection, causing the channel UI to be modified to display a subset of channel features for a channel membership of the selected channel owner.

In some implementations, the processing device is to perform operations further including receiving a selection of one or more features of the subset of channel features for the channel membership of the selected channel owner; and integrating the selected features into the channel membership of the channel of the first channel owner.

### BRIEF DESCRIPTION OF THE DRAWINGS

Aspects and implementations of the present disclosure will be understood more fully from the detailed description given below and from the accompanying drawings of various aspects and implementations of the disclosure, which, however, should not be taken to limit the disclosure to the specific aspects or implementations, but are for explanation and understanding only.

FIG. 1 illustrates an example system architecture, in accordance with implementations of the present disclosure.

FIG. 2 depicts a flow diagram of a method for identifying channel membership recommendations for a channel on a content platform, in accordance with implementations of the present disclosure.

FIG. 3A is a block diagram illustrating an example channel user interface (UI), in accordance with implementations of the present disclosure.

FIG. 3B is a block diagram illustrating another example channel user interface (UI), in accordance with implementations of the present disclosure.

FIG. 4 is a block diagram illustrating an exemplary computer system, in accordance with implementations of the present disclosure.

### DETAILED DESCRIPTION

Aspects of the present disclosure relate to identifying channel membership recommendations for a channel on a content platform.

A platform (e.g., a content sharing platform) can transmit media items to client devices connected to the platform via a network. A media item can include an audio item or a video item, in some instances. Users can consume the transmitted media items via a user interface (UI) provided by the platform. In some instances, media items can be provided to users through channels.

A channel can include content available from a common source and/or having a common topic or theme. A channel can be managed by the channel owner who can perform various management actions on the channel. Management actions may include, for example, adding media items to the channel, removing media items from the channel, defining subscription requirements for the channel, defining presentation attributes for channel content, defining access attributes for channel content, etc. The channel content can include media items uploaded to the content platform by the channel owner and/or media items selected by the channel owner from content available on the content platform. A channel owner can be, e.g., a professional content provider (e.g., a professional content creator, a professional content distributor, a content rental service, a television (TV) service, etc.), or an amateur individual. The channel content can include, e.g., professional content (e.g., movie clips, TV clips, music videos, educational videos) and/or amateur content (e.g., video blogging, short original videos, etc.).

Users of the platform can subscribe to one or more channels in which they are interested. Typically, subscribing to a channel provides users with free access to content (e.g., channel features) on the channel. In some instances, a channel owner may be interested in monetizing the channel by making some or all of the content (e.g., channel features) on the channel available to users who have a paid subscription to the channel (e.g., a channel membership). However, when creating a channel membership, the channel owner may not be able to select the channel features for offering to subscribers, such that the selected channel features would maximize the revenue-driving parameters of the channel (e.g., revenue, viewership, etc.). Further, when creating the channel membership, the channel owner may not be able to select the channel membership levels and fees of each level to offer to subscribers, such that the selected membership level and fee structure would maximize the revenue-driving parameters of the channel. Further, the channel owner may not be able to identify channel owners that are similar to the channel owner in certain aspects (e.g., channel owners that have a similar number of subscribers of a channel, channel owners that reside in a similar geographic region, channel owners that provide similar content type, etc.), such that the channel features for channel memberships of the identified similar channel owners can be derived and integrated into the channel membership for the channel owner.

Implementations of the present disclosure address the above and other deficiencies by identifying and presenting to the channel owner the information about the channel features of the channel memberships of channels of one or more channel owners that are similar to the channel owner in certain aspects (e.g., channel owners that have a similar number of subscribers of a channel, channel owners that reside in a similar geographic region, channel owners that provide similar content type, etc.), such that the channel owner can select one or more channel features from the features of the channel memberships of the channels of the one or more similar channel owners in order to create a channel membership for a channel of the channel owner. The channel features can include, for example, channel member loyalty badges, early access to content, channel members-only content, prioritization of channel owner's response to comments from channel members, channel members “shout-outs,” channel members status updates using media (e.g., images), channel members-only chat rooms, channel members-only social media connection with channel owner, channel members-only emojis, etc. In some embodiments, the channel owners that are similar to the channel owner can be identified by determining a respective channel owner similarity ranking for each channel owner based on a set of channel characteristics (e.g., a number of subscribers of a channel, a content type of a channel, the geographic regions in which the subscribers of a channel reside, a good standing status of a channel, a content quality of a channel, a number of channel memberships of a channel owner, etc.). If the channel owner similarity ranking for a channel owner satisfies a threshold channel owner similarity criterion (e.g., is greater than a threshold value), the channel owner can be identified as a similar channel owner.

In some embodiments, the channel user interface (UI) can be presented to the channel owner. The channel UI can provide the information about the channel features of the channel memberships of channels of the identified similar channel owners. For example, the channel UI can display the identified similar channel owners (e.g., using a visual representation). The channel owner who is creating the channel membership can then select one or more UI elements of the channel UI to select any of the identified similar channel owners. The channel UI can then be modified to display a subset of channel features for a channel membership of a channel of the selected similar channel owner. The channel owner can select one or more channel features of the subset of channel features for the channel membership of the selected similar channel owner, such that the one or more selected channel features can be integrated into the channel membership of the channel for the channel owner.

Thus, aspects of the present disclosure provide technical advantages over previous solutions. Aspects of the present disclosure can provide an automated tool for identifying similar channel owners in order to provide channel feature recommendations for creating a channel membership for a particular channel. Such an automated tool can be integrated into various services, such as content sharing platforms. Furthermore, recommending channel features can encourage the channel owner to provide channel membership to subscribers, which can result in longer user sessions, higher user interaction rates, etc., on the content platform.

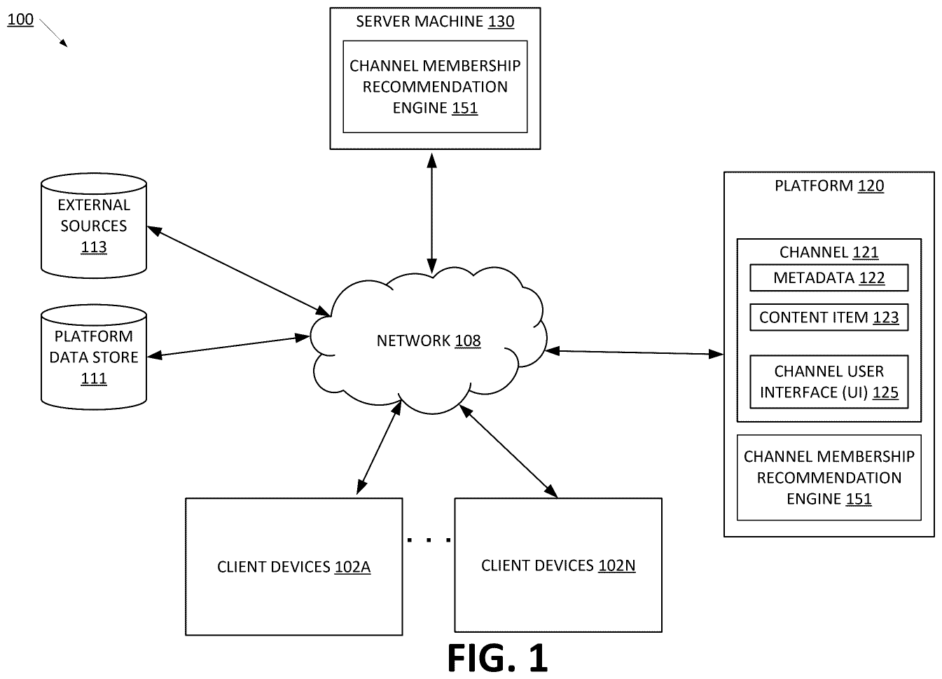

FIG. 1 illustrates an example system 100, in accordance with implementations of the present disclosure. The system 100 includes user devices 102A-N, a platform data store 111, a platform 120, and/or server machine 130, each connected to a network 108. In some implementations, network 108 can include a public network (e.g., the Internet), a private network (e.g., a local area network (LAN) or wide area network (WAN)), a wired network (e.g., Ethernet network), a wireless network (e.g., an 802.11 network or a Wi-Fi network), a cellular network (e.g., a Long Term Evolution (LTE) network), routers, hubs, switches, server computers, and/or a combination thereof.

In some implementations, platform data store 111 can be a persistent storage capable of storing data as well as data structures to tag, organize, and index the platform data. In some implementations, a data item of platform data can correspond to one or more portions of a content item for display to a content viewer via a graphical user interface (GUI) on a viewing user device 102, in accordance with implementations described herein. A data item can correspond to metadata for a content item, such as a content item title, transcript, description, length, or content item viewing statistics. In some implementations, a data item of platform data can correspond to one or more portions of a channel, including channel metadata such as a channel title, channel description, channel uploading user, or channel viewing statistics. Platform data store 111 can be hosted by one or more storage devices, such as main memory, magnetic or optical storage-based disks, tapes or hard drives, NAS, SAN, and so forth. In some implementations, platform data store 111 can be a network-attached file server, while in other implementations the platform data store 111 can be some other type of persistent storage such as an object-oriented database, a relational database, and so forth, that may be hosted by platform 120 or one or more different machines coupled to the platform 120 via network 108.

The client devices 102A-N can each include computing devices such as personal computers (PCs), laptops, mobile phones, smartphones, tablet computers, netbook computers, network-connected televisions, etc. Each client device 102 can include a content viewer. In some implementations, a content viewer can be an application that provides a user interface (UI) for users to view or upload content, such as images, video items, web pages, documents, etc. For example, the content viewer can be a web browser that can access, retrieve, present, and/or navigate content (e.g., web pages such as Hyper Text Markup Language (HTML) pages, digital content items, etc.) served by a web server. The content viewer can render, display, and/or present the content to a user. The content viewer can also include an embedded media player (e.g., a Flash® player or an HTML5 player) that is embedded in a web page (e.g., a web page that may provide information about a product sold by an online merchant). In another example, the content viewer can be a standalone application (e.g., a mobile application or app) that allows users to view digital content items (e.g., digital video items, digital images, electronic books, etc.). According to aspects of the disclosure, the content viewer can be a content platform application for users to record, edit, and/or upload content for sharing on platform 120. As such, the content viewers and/or the UI associated with the content viewer can be provided to client devices 102A-N by platform 120. In one example, the content viewers can be embedded media players that are embedded in web pages provided by the platform 120.

Platform 120 can include one or more channels 121. A channel 121 can include metadata 122 associated with the channel 121, and one or more content items 123 available from a common source, or content items 123 having a common topic, theme, or substance. Metadata 122 can include various information pertinent to the channel 121, such as a title, description, date, usage statistics, or content language. In some implementations, metadata 122 can include information about the one or more content items 123 of channel 121. For example, metadata 122 can include information about content item 123, such as a title, description, date, identity of channel owner, usage statistics, or language.

A channel 121 can represent one or more content item 123 (e.g., digital content) chosen by a user, digital content made available by a user, digital content uploaded by a user, digital content chosen by a content provider, digital content chosen by a broadcaster, etc. For example, a channel X can include videos Y and Z. A channel can be associated with a channel owner, who is a user that can perform actions on the channel. Different activities can be associated with the channel 121 based on the channel owner's actions, such as the channel owner making digital content available on the channel 121, the channel owner selecting (e.g., liking) digital content associated with another channel 121, the channel owner commenting on digital content associated with another channel 121, etc. The activities associated with the channel 121 can be collected into an activity feed for the channel 121. Users, other than the owner of the channel 121, can subscribe to one or more channels 121 in which they are interested. The concept of “subscribing” may also be referred to as “liking,” “following,” “friending,” and so on.

A content item 123 can be consumed via the Internet or via a mobile device application, such as a content viewer of viewing client devices 102A-N. In some implementations, a content item 123 can correspond to a media file (e.g., a video file, an audio file, a video stream, an audio stream, etc.). In other or similar implementations, a content item 123 can correspond to a portion of a media file (e.g., a portion or a chunk of a video file, an audio file, etc.). As discussed previously, a content item 123 can be requested for presentation to the user by the user of the platform 120. As used herein, “content item” can include an electronic file that can be executed or loaded using software, firmware or hardware configured to digitally present the content item to an entity. As indicated above, in at least one implementation, the platform 120 can store the content items 123, or references to the content items 123, using the platform data store 111. In some implementations, the platform 120 can store the content item 123 or fingerprints as electronic files in one or more formats using platform data store 111.

In some implementations, content item 123 can be a video item. A video item refers to a set of sequential video frames (e.g., image frames) representing a scene in motion. For example, a series of sequential video frames can be captured continuously or later reconstructed to produce animation. Video items can be provided in various formats including, but not limited to, analog, digital, two-dimensional and three-dimensional video. Further, video items can include movies, video clips, video streams, or any set of images (e.g., animated images, non-animated images, etc.) to be displayed in sequence. In some implementations, a video item can be stored (e.g., at platform data store 111) as a video file that includes a video component and an audio component. The video component can include video data that corresponds to one or more sequential video frames of the video item. The audio component can include audio data that corresponds to the video data.

In some implementations, platform 120 and/or server machine 130 can be one or more computing devices (such as a rackmount server, a router computer, a server computer, a personal computer, a mainframe computer, a laptop computer, a tablet computer, a desktop computer, etc.), data stores (e.g., hard disks, memories, databases), networks, software components, and/or hardware components. Platform 120 can include channel 121. Channel 121 can be made accessible through platform 120. In some implementations, platform 120 can facilitate the access of channel 121, or information about channel 121 through channel user interface (UI) 125.

In some implementations, the functions of server machine 130 or platform 120 may be provided by a fewer number of machines. For example, in some implementations, the server machine 130 can be integrated into platform 120. In some implementations, the server machine 130 can be integrated separately from platform 120. In addition, the functionality attributed to a specific component can be performed by different or multiple components operating together. Platform 120 can also be accessed as a service provided to other systems or devices through appropriate application programming interfaces, and thus is not limited to use in websites.

In situations in which the systems discussed here collect personal information about users, or may make use of personal information, the users may be provided with an opportunity to control whether platform 120 collects user information (e.g., information about a user's social network, social actions or activities, profession, a user's preferences, or a user's current location), or to control whether and/or how to receive content from the server 130 that may be more relevant to the user. In addition, certain data may be treated in one or more ways before it is stored or used, so that personally identifiable information is removed. For example, a user's identity may be treated so that no personally identifiable information can be determined for the user, or a user's geographic location may be generalized where location information is obtained (such as to a city, ZIP code, or state level), so that a particular location of a user cannot be determined. Thus, the user may have control over how information is collected about the user and used by the platform 120 and/or server 130.

In various implementations of the disclosure, a “user” can be represented by a single individual. However, other implementations of the disclosure encompass a “user” being an entity controlled by a group of individuals and/or an automated source. For example, a group of individuals federated as a community in a social network can be considered a “user.” Further to the descriptions above, a user can be provided with controls allowing the user to make an election as to both if and when systems, programs, or features described can enable collection of user information (e.g., information about a user's social network, social actions, or activities, profession, a user's preferences, or a user's current location), and if the user is sent content or communications from a server. In addition, certain data can be treated in one or more ways before it is stored or used, so that personally identifiable information is removed. For example, a user's identity can be treated so that no personally identifiable information can be determined for the user, or a user's geographic location can be generalized where location information is obtained (such as to a city, ZIP code, or state level), so that a particular location of a user cannot be determined. Thus, the user can have control over what information is collected about the user, how that information is used, and what information is provided to the user.

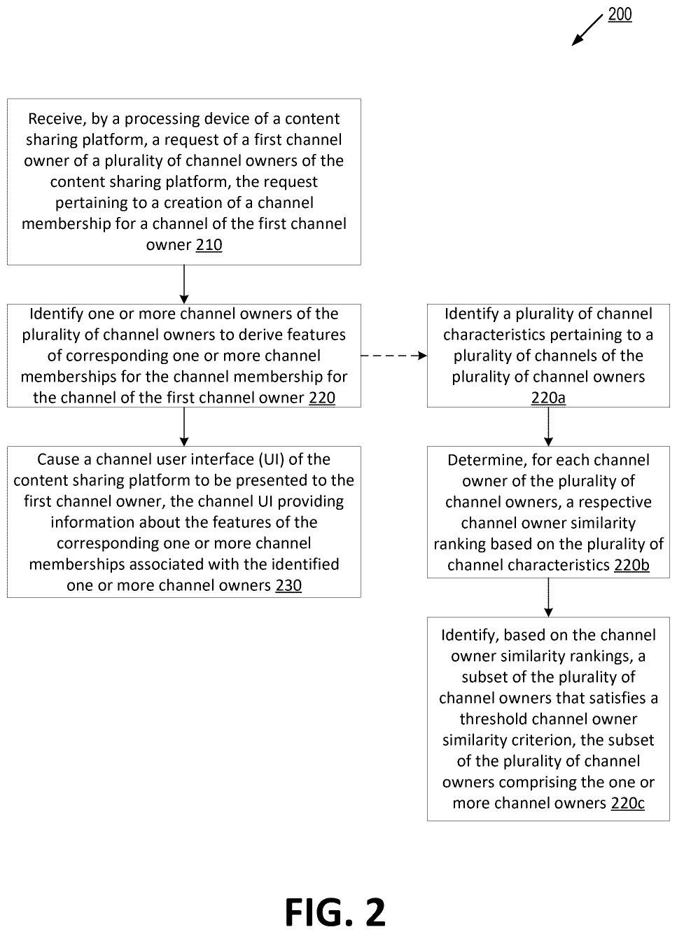

FIG. 2 depicts a flow diagram of a method for identifying channel membership recommendations for a channel on a content platform, in accordance with implementations of the present disclosure. Method 200 may be performed by processing logic that may include hardware (circuitry, dedicated logic, etc.), software (e.g., instructions run on a processing device), or a combination thereof. In one implementation, some or all the operations of method 200 may be performed by one or more components of system 100 of FIG. 1 (e.g., platform 120, server(s) 130, and/or channel membership recommendation engine 151).

For simplicity of explanation, the method 200 of this disclosure is depicted and described as a series of acts. However, acts in accordance with this disclosure can occur in various orders and/or concurrently, and with other acts not presented and described herein. Furthermore, not all illustrated acts may be required to implement the method 200 in accordance with the disclosed subject matter. In addition, those skilled in the art will understand and appreciate that the method 200 could alternatively be represented as a series of interrelated states via a state diagram or events. Additionally, it should be appreciated that the method 200 disclosed in this specification are capable of being stored on an article of manufacture (e.g., a computer program accessible from any computer-readable device or storage media) to facilitate transporting and transferring such method to computing devices. The term “article of manufacture,” as used herein, is intended to encompass a computer program accessible from any computer-readable device or storage media.

At block 210, the processing logic receives a request of a channel owner (e.g., a first channel owner) of a set of channel owners of a content platform (e.g., platform 120 of FIG. 1), pertaining to a creation of a channel membership recommendation for a channel of the first channel owner. In some implementations, the channel can be associated with content items (e.g., content item 123 of FIG. 1) and/or metadata (e.g., metadata 122 of FIG. 1).

At block 220, the processing logic identifies one or more channel owners of the set of channel owners. In some embodiments, the processing logic identifies the one or more channel owners of the set of channel owners to derive channel features of corresponding one or more channel memberships of one or more channels of the identified one or more channel owners. In some embodiments, the derived channel features can be derived for the channel membership of the first channel owner (e.g., for use in creating the channel membership and/or in modifying channel features of the channel membership). In some implementations, the operations of block 220 can further include operations of blocks 220a-220c.

At block 220a, the processing logic identifies a set of channel characteristics that pertain to a set of channels of the set of channel owners. For example, the set of channel characteristics can include a number of subscribers of a channel of the set of channels of a channel owner of the set of channel owners, a content type of a channel of the set of channels of a channel owner of the set of channel owners, a language of a channel of the set of channels of a channel owner of the set of channel owners, a geographic region in which one or more subscribers of a channel of the set of channels of a channel owner of the set of channel owners resides, a good standing status of a channel of the set of channels of a channel owner of the set of channel owners (e.g., the channel is not associated with any legal and/or platform 120 policy violations), a content quality of a channel of the set of channels of a channel owner of the set of channel owners (e.g., where the content quality standard can be set by the platform 120), a number of channel memberships of a channel owner of the set of channel owners, etc. In some embodiments, identifying the set of channel characteristics includes the processing logic retrieving the set of channel characteristics from a data store associated with the platform 120 (e.g., the platform data store 111 of FIG. 1).

In some embodiments, in response to identifying the set of channel characteristics, the processing logic can remove (e.g., filter) one or more channel owners from the set of channel owners based on one or more channel characteristics of the set of channel characteristics. For example, the one or more channel characteristics can be predetermined by the platform 120 and can be used as an initial filtering of the set of channel owners prior to performing the operations at blocks 220b-c and 230. For example, the one or more channel characteristics can include a language of a channel of the set of channels of a channel owner of the set of channel owners and/or a geographic region in which one or more subscribers of a channel of the set of channels of a channel owner of the set of channel owners resides. The processing logic can compare the one or more channel characteristics of the channel of the first channel owner to the one or more channel characteristics of another (e.g., a second) channel of another (e.g., a second) channel owner (e.g., using a similarity measure that computes a similarity score between the one or more channel characteristics of the channel of the first channel owner and the one or more channel characteristics of the second channel of the second channel owner). In response to determining a difference in the similarity score between the one or more channel characteristics of the channel of the first channel owner and the second channel of the second channel owner (e.g., that the similarity scores of the one or more channel characteristics of the channel and the second channel are not equal in value), the processing logic can remove the second channel owner from the set of channel owners. For example, the processing logic can determine that the language of the channel of the first channel owner is English and that the language of the second channel of the second channel owner is Spanish. In response to determining a difference in similarity scores between the languages of the channel of the first channel owner and the second channel of the second channel owner, the processing logic can remove the second channel owner from the set of channel owners.

At block 220b, the processing logic determines, for each channel owner of the set of channel owners, a respective channel owner similarity ranking. In some embodiments, the processing logic determines the respective channel owner similarity ranking based on the set of channel characteristics identified at block 220a. For example, the processing logic can compare a channel characteristic of the channel of the first channel owner to a channel characteristic of another (e.g., a second) channel of another (e.g., a second) channel owner of the set of channel owners (e.g., using a similarity measure that computes a similarity score between the one or more channel characteristics of the channel of the first channel owner and the one or more channel characteristics of the second channel of the second channel owner). The processing logic can determine, based on the comparing, a channel owner similarity ranking of the second channel owner of the set of channel owners.

At block 220c, the processing logic identifies a subset of the set of channel owners that satisfies a threshold channel owner similarity criterion. For example, the processing logic identifies the subset of the set of channel owners that satisfies the threshold channel owner similarity criterion based on the channel owner similarity rankings determined at block 220b. For example, the processing logic can determine that a respective channel owner similarity ranking of a second channel owner exceeds (e.g., is greater than) a threshold channel owner similarity value that is defined by the threshold channel owner similarity criterion. In response to determining that the respective channel owner similarity ranking of the second channel owner exceeds the threshold channel owner similarity value, the processing logic can associate (e.g., group) the second channel owner with the subset of the set of channel owners that satisfies the threshold channel owner similarity criterion.

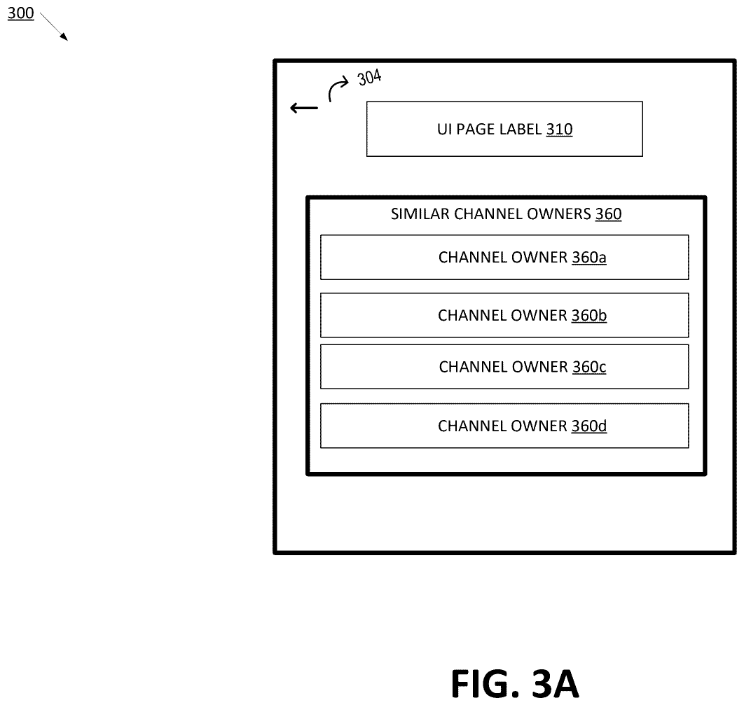

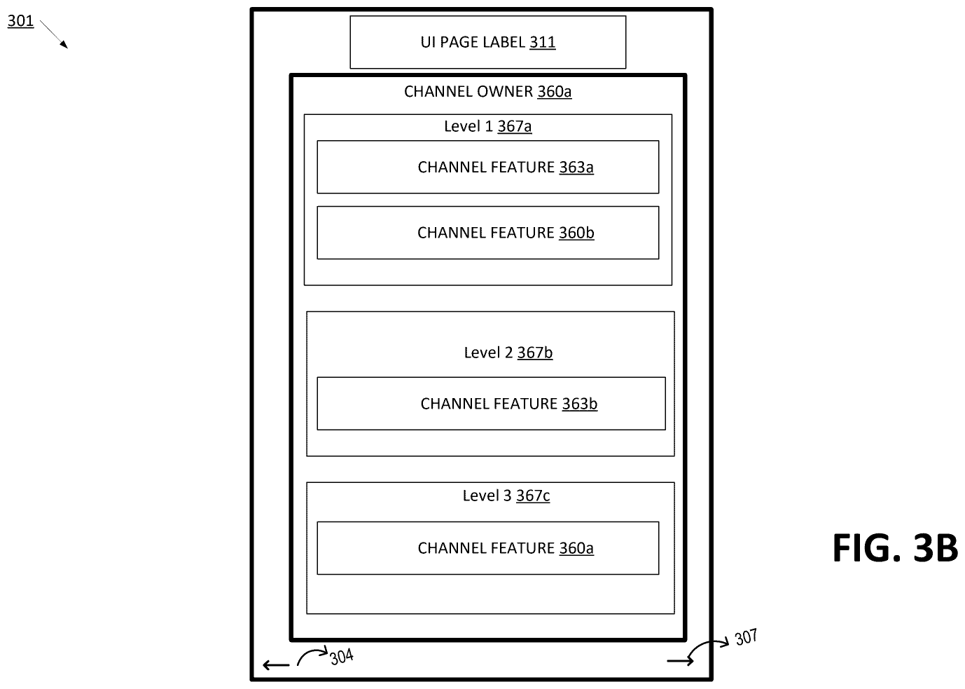

At block 230, the processing logic causes a channel user interface (UI) of the content sharing platform (e.g., the channel UI 125 of FIG. 1 and/or channel UI 300 of FIG. 3) to be presented to the first channel owner. In an illustrative example, referring to FIG. 3A, the processing logic can cause the channel UI 300 to be presented to the first channel owner. The channel UI 300 can include a UI page label 310 (e.g., an identifier of the UI page, such as “Channel Memberships,” “Memberships,” “Choose Channel Features,” “Choose Perks,” etc.), a UI element 304 (e.g., a back button that can be selectable to go back to a previous page in the channel UI 300), a display area for a set of similar channel owners 360, where the set of similar channel owners 360 includes one or more similar channel owners (e.g., 360a-360d). The channel UI 300 can provide information about the features of corresponding one or more channel memberships associated with the identified one or more channel owners (e.g., the one or more channel owners identified at block 220). In some embodiments, the channel UI can display the identified similar channel owners 360 using a visual representation, such as an avatar of each identified similar channel owner. In some embodiments, the channel UI can display the identified similar channel owners 360 using a textual description of each identified similar channel owner, such as an identifier and/or name of each identified similar channel owner.

The first channel owner who is creating the channel membership can then select one or more UI elements of the channel UI to select any of the identified similar channel owners. The channel UI can then be modified to display a subset of channel features for a channel membership of a channel of the selected similar channel owner. The first channel owner can select one or more channel features of the subset of channel features for the channel membership of the selected similar channel owner, such that the one or more selected channel features can be integrated into the channel membership of the channel for the first channel owner. In an illustrative example, referring to FIG. 3B, in response to receiving a selection of any of the identified similar channel owners (e.g., in the channel UI 300 of FIG. 3A), the processing logic can cause the channel UI 301 to be presented to the first channel owner. The channel UI 300 can include a UI page label 311 (e.g., an identifier of the UI page, a UI element 304 (e.g., a back button that can be selectable to go back to a previous page in the channel UI 300), a UI element 307 (e.g., a forward button that can be selectable to go forward to a subsequent page in the channel UI 301), a display area for the selected similar channel owner (e.g., channel owner 360a), a set of channel membership levels and corresponding channel features associated with each channel membership level for the channel membership of a channel of the selected similar channel owner. For example, the set of channel membership levels can include level 1 367a, which can include corresponding channel features 363a, 360b; level 2 367b, which can include corresponding channel features 363b; and level 3 365, which can include corresponding channel features 360a. The first channel owner can select (e.g., using one or more UI elements in the channel UI 301) one or more channel features of the subset of channel features for the channel membership of the selected similar channel owner, such that the one or more selected channel features can be integrated into the channel membership of the channel for the first channel owner. The channel features can include, for example, channel member loyalty badges, early access to content, channel members-only content, prioritization of channel owner's response to comments from channel members, channel members “shout-outs,” channel members status updates using media (e.g., images), channel members-only chat rooms, channel members-only social media connection with channel owner, channel members-only custom emojis, video collaborations between the channel owner and a channel member, virtual meet-and-greet between the channel owner and a channel member, exclusive merchandise, game play with the channel owner, behind-the-scenes content (e.g., videos), rough cuts and/or bloopers of content, wallpapers that are exclusive to one or more channels of the channel owner and/or channel owner, discounted merchandise of the channel owner, access to archived content (e.g., videos, livestreams, etc.), default channel member badges, channel members-only polls, etc.

FIG. 3A is a block diagram illustrating an example channel user interface (UI), in accordance with implementations of the present disclosure. FIG. 3A is described with respect to FIG. 2 herein above.

FIG. 3B is a block diagram illustrating an example channel user interface (UI), in accordance with implementations of the present disclosure. FIG. 3B is described with respect to FIG. 2 herein above.

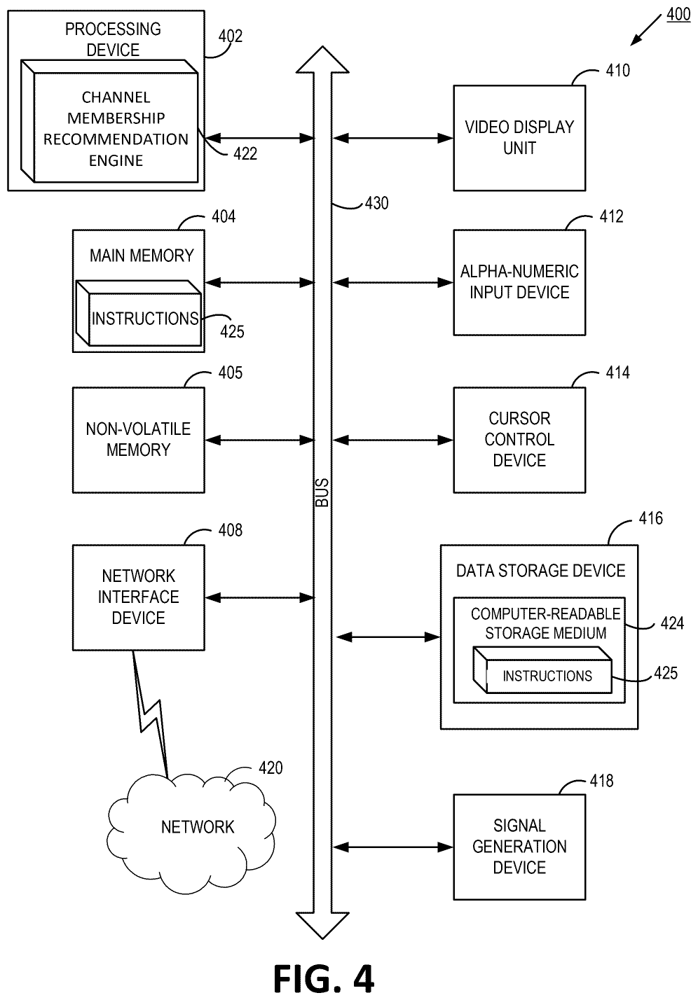

FIG. 4 is a block diagram illustrating an exemplary computer system, in accordance with implementations of the present disclosure. The computer system 400 can be the server 130, 133, and/or 150 or client devices 102A-N in FIG. 1. The machine can operate in the capacity of a server or an endpoint machine in endpoint-server network environment, or as a peer machine in a peer-to-peer (or distributed) network environment. The machine can be a television, a personal computer (PC), a tablet PC, a set-top box (STB), a Personal Digital Assistant (PDA), a cellular telephone, a web appliance, a server, a network router, switch or bridge, or any machine capable of executing a set of instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein.

The example computer system 400 includes a processing device (processor) 402, a main memory 404 (e.g., read-only memory (ROM), flash memory, dynamic random access memory (DRAM) such as synchronous DRAM (SDRAM), double data rate (DDR SDRAM), or DRAM (RDRAM), etc.), a static memory 406 (e.g., flash memory, static random access memory (SRAM), etc.), and a data storage device 418, which communicate with each other via a bus 440.

Processor (processing device) 402 represents one or more general-purpose processing devices such as a microprocessor, central processing unit, or the like. More particularly, the processor 402 can be a complex instruction set computing (CISC) microprocessor, reduced instruction set computing (RISC) microprocessor, very long instruction word (VLIW) microprocessor, or a processor implementing other instruction sets or processors implementing a combination of instruction sets. The processor 402 can also be one or more special-purpose processing devices such as an application specific integrated circuit (ASIC), a field programmable gate array (FPGA), a digital signal processor (DSP), network processor, or the like. The processor 402 is configured to execute instructions 405 (e.g., for identifying channel membership recommendations for a channel on a content platform) for performing the operations discussed herein.

The computer system 400 can further include a network interface device 408. The computer system 400 also can include a video display unit 410 (e.g., a liquid crystal display (LCD) or a cathode ray tube (CRT)), an input device 412 (e.g., a keyboard, and alphanumeric keyboard, a motion sensing input device, touch screen), a cursor control device 414 (e.g., a mouse), and a signal generation device 420 (e.g., a speaker).

The data storage device 418 can include a non-transitory machine-readable storage medium 424 (also computer-readable storage medium) on which is stored one or more sets of instructions 405 (e.g., for identifying channel membership recommendations for a channel on a content platform) embodying any one or more of the methodologies or functions described herein. The instructions can also reside, completely or at least partially, within the main memory 404 and/or within the processor 402 during execution thereof by the computer system 400, the main memory 404 and the processor 402 also constituting machine-readable storage media. The instructions can further be transmitted or received over a network 430 via the network interface device 408.

In one implementation, the instructions 405 include instructions for identifying channel feature recommendations for a channel membership for presentation on a content platform. While the computer-readable storage medium 424 (machine-readable storage medium) is shown in an exemplary implementation to be a single medium, the terms “computer-readable storage medium” and “machine-readable storage medium” should be taken to include a single medium or multiple media (e.g., a centralized or distributed database, and/or associated caches and servers) that store the one or more sets of instructions. The terms “computer-readable storage medium” and “machine-readable storage medium” shall also be taken to include any medium that is capable of storing, encoding or carrying a set of instructions for execution by the machine and that cause the machine to perform any one or more of the methodologies of the present disclosure. The terms “computer-readable storage medium” and “machine-readable storage medium” shall accordingly be taken to include, but not be limited to, solid-state memories, optical media, and magnetic media.

Reference throughout this specification to “one implementation,” or “an implementation,” means that a particular feature, structure, or characteristic described in connection with the implementation is included in at least one implementation. Thus, the appearances of the phrase “in one implementation,” or “in an implementation,” in various places throughout this specification can, but are not necessarily, referring to the same implementation, depending on the circumstances. Furthermore, the particular features, structures, or characteristics may be combined in any suitable manner in one or more implementations.

To the extent that the terms “includes,” “including,” “has,” “contains,” variants thereof, and other similar words are used in either the detailed description or the claims, these terms are intended to be inclusive in a manner similar to the term “comprising” as an open transition word without precluding any additional or other elements.

As used in this application, the terms “component,” “module,” “system,” or the like are generally intended to refer to a computer-related entity, either hardware (e.g., a circuit), software, a combination of hardware and software, or an entity related to an operational machine with one or more specific functionalities. For example, a component may be, but is not limited to being, a process running on a processor (e.g., digital signal processor), a processor, an object, an executable, a thread of execution, a program, and/or a computer. By way of illustration, both an application running on a controller and the controller can be a component. One or more components may reside within a process and/or thread of execution and a component may be localized on one computer and/or distributed between two or more computers. Further, a “device” can come in the form of specially designed hardware; generalized hardware made specialized by the execution of software thereon that enables hardware to perform specific functions (e.g., generating interest points and/or descriptors); software on a computer readable medium; or a combination thereof.

The aforementioned systems, circuits, modules, and so on have been described with respect to interact between several components and/or blocks. It can be appreciated that such systems, circuits, components, blocks, and so forth can include those components or specified sub-components, some of the specified components or sub-components, and/or additional components, and according to various permutations and combinations of the foregoing. Sub-components can also be implemented as components communicatively coupled to other components rather than included within parent components (hierarchical). Additionally, it should be noted that one or more components may be combined into a single component providing aggregate functionality or divided into several separate sub-components, and any one or more middle layers, such as a management layer, may be provided to communicatively couple to such sub-components in order to provide integrated functionality. Any components described herein may also interact with one or more other components not specifically described herein but known by those of skill in the art.

Moreover, the words “example” or “exemplary” are used herein to mean serving as an example, instance, or illustration. Any aspect or design described herein as “exemplary” is not necessarily to be construed as preferred or advantageous over other aspects or designs. Rather, use of the words “example” or “exemplary” is intended to present concepts in a concrete fashion. As used in this application, the term “or” is intended to mean an inclusive “or” rather than an exclusive “or.” That is, unless specified otherwise, or clear from context, “X employs A or B” is intended to mean any of the natural inclusive permutations. That is, if X employs A; X employs B; or X employs both A and B, then “X employs A or B” is satisfied under any of the foregoing instances. In addition, the articles “a” and “an” as used in this application and the appended claims should generally be construed to mean “one or more” unless specified otherwise or clear from context to be directed to a singular form.

Finally, implementations described herein include collection of data describing a user and/or activities of a user. In one implementation, such data is only collected upon the user providing consent to the collection of this data. In some implementations, a user is prompted to explicitly allow data collection. Further, the user may opt-in or opt-out of participating in such data collection activities. In one implementation, the collect data is anonymized prior to performing any analysis to obtain any statistical patterns so that the identity of the user cannot be determined from the collected data.

What is claimed is:

1. A method comprising:
receiving, by a processing device of a content sharing platform, a request of a first channel owner of a plurality of channel owners of the content sharing platform, the request pertaining to a creation of a channel membership for a channel of the first channel owner;
identifying one or more channel owners of the plurality of channel owners to derive features of corresponding one or more channel memberships for the channel membership for the channel of the first channel owner, wherein identifying the one or more channel owners comprises:
identifying a plurality of channel characteristics pertaining to a plurality of channels of the plurality of channel owners;
determining, for each channel owner of the plurality of channel owners, a respective channel owner similarity ranking based on the plurality of channel characteristics; and
identifying, based on the channel owner similarity rankings, a subset of the plurality of channel owners that satisfies a threshold channel owner similarity criterion, the subset of the plurality of channel owners comprising the one or more channel owners; and
causing a channel user interface (UI) of the content sharing platform to be presented to the first channel owner, the channel UI providing information about the features of the corresponding one or more channel memberships associated with the identified one or more channel owners.

2. The method of claim 1, wherein the plurality of channel characteristics pertaining to the plurality of channels of the plurality of channel owners comprises at least one or more of: a number of subscribers of a channel of the plurality of channels of a channel owner of the plurality of channel owners, a content type of a channel of the plurality of channels of a channel owner of the plurality of channel owners, a language of a channel of the plurality of channels of a channel owner of the plurality of channel owners, a geographic region in which one or more subscribers of a channel of the plurality of channels of a channel owner of the plurality of channel owners resides, a good standing status of a channel of the plurality of channels of a channel owner of the plurality of channel owners, a content quality of a channel of the plurality of channels of a channel owner of the plurality of channel owners, or a number of channel memberships of a channel owner of the plurality of channel owners.

3. The method of claim 1, wherein determining the respective channel owner similarity ranking comprises:
comparing a channel characteristic of the channel of the first channel owner to a channel characteristic of a second channel of a second channel owner of the plurality of channel owners; and
determining, based on the comparing, a channel owner similarity ranking of the second channel owner of the plurality of channel owners.

4. The method of claim 1, wherein identifying the subset of the plurality of channel owners that satisfies the threshold channel owner similarity criterion comprises:
determining, for a second channel owner of the plurality of channel owners, that the respective channel owner similarity ranking of the second channel owner exceeds a threshold channel owner similarity value; and
in response to determining that the respective channel owner similarity ranking of the second channel owner exceeds the threshold channel owner similarity value, associating the second channel owner with the subset of the plurality of channel owners that satisfies the threshold channel owner similarity criterion.

5. The method of claim 1, further comprising:
in response to identifying the plurality of channel characteristics pertaining to the plurality of channels of the plurality of channel owners, removing, based on one or more channel characteristics of the plurality of channel characteristics, one or more channel owners from the plurality of channel owners.

6. The method of claim 1, wherein the channel UI displays one or more visual representations of the one or more channel owners.

7. The method of claim 1, wherein causing the channel UI of the content sharing platform to be presented to the first channel owner further comprises:
displaying the identified one or more channel owners;
receiving, from the first channel owner, a selection of one or more UI elements of the channel UI, wherein the one or more UI elements are selectable to allow the first channel owner to select any of the identified one or more channel owners; and
in response to receiving the selection, causing the channel UI to be modified to display a subset of channel features for a channel membership of the selected channel owner.

8. The method of claim 7, further comprising:
receiving a selection of one or more features of the subset of channel features for the channel membership of the selected channel owner; and
integrating the selected features into the channel membership of the channel of the first channel owner.

9. A system comprising:
a memory device; and
a processing device coupled to the memory device, the processing device to perform operations comprising:
receiving a request of a first channel owner of a plurality of channel owners of a content sharing platform, the request pertaining to a creation of a channel membership for a channel of the first channel owner;
identifying one or more channel owners of the plurality of channel owners to derive features of corresponding one or more channel memberships for the channel membership for the channel of the first channel owner, wherein identifying the one or more channel owners comprises:
identifying a plurality of channel characteristics pertaining to a plurality of channels of the plurality of channel owners;
determining, for each channel owner of the plurality of channel owners, a respective channel owner similarity ranking based on the plurality of channel characteristics; and
identifying, based on the channel owner similarity rankings, a subset of the plurality of channel owners that satisfies a threshold channel owner similarity criterion, the subset of the plurality of channel owners comprising the one or more channel owners; and
causing a channel user interface (UI) of the content sharing platform to be presented to the first channel owner, the channel UI providing information about the features of the corresponding one or more channel memberships associated with the identified one or more channel owners.

10. The system of claim 9, wherein the plurality of channel characteristics pertaining to the plurality of channels of the plurality of channel owners comprises at least one or more of: a number of subscribers of a channel of the plurality of channels of a channel owner of the plurality of channel owners, a content type of a channel of the plurality of channels of a channel owner of the plurality of channel owners, a language of a channel of the plurality of channels of a channel owner of the plurality of channel owners, a geographic region in which one or more subscribers of a channel of the plurality of channels of a channel owner of the plurality of channel owners resides, a good standing status of a channel of the plurality of channels of a channel owner of the plurality of channel owners, a content quality of a channel of the plurality of channels of a channel owner of the plurality of channel owners, or a number of channel memberships of a channel owner of the plurality of channel owners.

11. The system of claim 9, wherein to determine the respective channel owner similarity ranking, the processing device is to perform operations further comprising:
comparing a channel characteristic of the channel of the first channel owner to a channel characteristic of a second channel of a second channel owner of the plurality of channel owners; and
determining, based on the comparing, a channel owner similarity ranking of the second channel owner of the plurality of channel owners.

12. The system of claim 9, wherein to identify the subset of the plurality of channel owners that satisfies the threshold channel owner similarity criterion, the processing device is to perform operations further comprising:
determining, for a second channel owner of the plurality of channel owners, that the respective channel owner similarity ranking of the second channel owner exceeds a threshold channel owner similarity value; and
in response to determining that the respective channel owner similarity ranking of the second channel owner exceeds the threshold channel owner similarity value, associating the second channel owner with the subset of the plurality of channel owners that satisfies the threshold channel owner similarity criterion.

13. The system of claim 9, wherein the processing device is to perform operations further comprising:
in response to identifying the plurality of channel characteristics pertaining to the plurality of channels of the plurality of channel owners, removing, based on one or more channel characteristics of the plurality of channel characteristics, one or more channel owners from the plurality of channel owners.

14. The system of claim 9, wherein to cause the channel UI of the content sharing platform to be presented to the first channel owner, the processing device is to perform operations further comprising:
displaying the identified one or more channel owners;
receiving, from the first channel owner, a selection of one or more UI elements of the channel UI, wherein the one or more UI elements are selectable to allow the first channel owner to select any of the identified one or more channel owners; and
in response to receiving the selection, causing the channel UI to be modified to display a subset of channel features for a channel membership of the selected channel owner.

15. A non-transitory computer readable storage medium comprising instructions for a server that, when executed by a processing device, cause the processing device to perform operations comprising:
receiving a request of a first channel owner of a plurality of channel owners of a content sharing platform, the request pertaining to a creation of a channel membership for a channel of the first channel owner;
identifying one or more channel owners of the plurality of channel owners to derive features of corresponding one or more channel memberships for the channel membership for the channel of the first channel owner, wherein identifying the one or more channel owners comprises:
identifying a plurality of channel characteristics pertaining to a plurality of channels of the plurality of channel owners;
determining, for each channel owner of the plurality of channel owners, a respective channel owner similarity ranking based on the plurality of channel characteristics; and
identifying, based on the channel owner similarity rankings, a subset of the plurality of channel owners that satisfies a threshold channel owner similarity criterion, the subset of the plurality of channel owners comprising the one or more channel owners; and
causing a channel user interface (UI) of the content sharing platform to be presented to the first channel owner, the channel UI providing information about the features of the corresponding one or more channel memberships associated with the identified one or more channel owners.

16. The non-transitory computer readable storage medium of claim 15, wherein the plurality of channel characteristics pertaining to the plurality of channels of the plurality of channel owners comprises at least one or more of: a number of subscribers of a channel of the plurality of channels of a channel owner of the plurality of channel owners, a content type of a channel of the plurality of channels of a channel owner of the plurality of channel owners, a language of a channel of the plurality of channels of a channel owner of the plurality of channel owners, a geographic region in which one or more subscribers of a channel of the plurality of channels of a channel owner of the plurality of channel owners resides, a good standing status of a channel of the plurality of channels of a channel owner of the plurality of channel owners, a content quality of a channel of the plurality of channels of a channel owner of the plurality of channel owners, or a number of channel memberships of a channel owner of the plurality of channel owners.

17. The non-transitory computer readable storage medium of claim 15, wherein to determine the respective channel owner similarity ranking, the processing device is to perform operations further comprising:
comparing a channel characteristic of the channel of the first channel owner to a channel characteristic of a second channel of a second channel owner of the plurality of channel owners; and
determining, based on the comparing, a channel owner similarity ranking of the second channel owner of the plurality of channel owners.

18. The non-transitory computer readable storage medium of claim 15, wherein to identify the subset of the plurality of channel owners that satisfies the threshold channel owner similarity criterion, the processing device is to perform operations further comprising:
determining, for a second channel owner of the plurality of channel owners, that the respective channel owner similarity ranking of the second channel owner exceeds a threshold channel owner similarity value; and
in response to determining that the respective channel owner similarity ranking of the second channel owner exceeds the threshold channel owner similarity value, associating the second channel owner with the subset of the plurality of channel owners that satisfies the threshold channel owner similarity criterion.

19. The non-transitory computer readable storage medium of claim 15, wherein the processing device is to perform operations further comprising:
in response to identifying the plurality of channel characteristics pertaining to the plurality of channels of the plurality of channel owners, removing, based on one or more channel characteristics of the plurality of channel characteristics, one or more channel owners from the plurality of channel owners.

20. The non-transitory computer readable storage medium of claim 15, wherein to cause the channel UI of the content sharing platform to be presented to the first channel owner, the processing device is to perform operations further comprising:
displaying the identified one or more channel owners;
receiving, from the first channel owner, a selection of one or more UI elements of the channel UI, wherein the one or more UI elements are selectable to allow the first channel owner to select any of the identified one or more channel owners; and
in response to receiving the selection, causing the channel UI to be modified to display a subset of channel features for a channel membership of the selected channel owner.
